(19) United States
(12) Patent Application Publication
(10) Pub. No.: US 2007/0054982 A1
(43) Pub. Date: Mar. 8, 2007

(54) Impact-modified blends of polycarbonate and polyester

(76) Inventors: Asis K. Banerjie, Avon, OH (US); Marina Rogunova, Avon, OH (US)

Correspondence Address: POLYONE CORPORATION, 33587 WALKER ROAD, AVON LAKE, OH, 44012, US

(21) Appl. No.: 10/571,028

(22) PCT Filed: Jul. 19, 2004
(86) PCT No.: PCT/US04/23195

§ 371 Date: Mar. 8, 2006

Related U.S. Application Data
(60) Provisional application No. 60/505,223, filed on Sep. 23, 2003.

(51) Int. Cl. C09D 151/00

(52) U.S. Cl. 523/201

(57) ABSTRACT

A tri-block copolymer is disclosed for use in thermoplastic blends. The tri-block copolymer comprises an aromatic monomer, an olefin monomer, and a alkyl (meth)acrylate monomer. One use is for a thermoplastic polymer blend which comprises (a) at least one thermoplastic polycondensate polymer, preferably both a polycarbonate and a polyester, and (b) a combination of impact modifiers. The combination of impact modifiers comprises (i) a core/shell additive having an elastomeric core, (ii) a linear terpolymer of ethylene, alkyl (meth)acrylate, and a monomer which contains a heterocycle containing one oxygen atom as the hetero-atom, and (iii) the tri-block copolymer. A second use is the tri-block copolymer as the sole impact modifier for a blend of polycarbonate and polyester.

### CLAIM OF PRIORITY

This application claims priority from U.S. Provisional Patent Application Ser. No. 60/505,223 bearing Attorney Docket Number 12003013 and filed on Sep. 23, 2003.

### FIELD OF THE INVENTION

This invention relates the use of a tri-block copolymer as an impact modifier alone in blends of polyester and polycarbonate and together with other impact modifiers in blends of at least one polycondensate polymer.

### BACKGROUND OF THE INVENTION

Blends of polycarbonate and polyester and their need for impact modification are well known. For example, European Patent Publication EP1207172A2 discloses an improved impact modifier for blends of polyester with other polymers, including polycarbonate, wherein the impact modifier itself is a blend of a core/shell additive and a linear copolymer of olefin, alkyl acrylate, and glycidyl methacrylate monomers.

### SUMMARY OF THE INVENTION

What is needed is better impact modification for blends of polycondensate polymers, particularly polycarbonate (PC) and polyester, especially polyethylene terephthalate (PET) or polybutylene terephthalate (PBT). There is a need to produce blends which have good impact properties, smooth surface finishes, weatherability, scratch resistance, solvent resistance, and a balance of flexural modulus, heat distortion temperature, and impact properties.

The present invention provides use of a new impact modifier that enhances impact properties throughout service temperatures (−40° C.-70° C.) for blends, particularly PC-PET or PC-PBT blends without compromising heat distortion temperature or flexural modulus properties. The new impact modifier can be used alone, or optionally in combination with the impact modifiers disclosed in EP1207172A2. The new impact modifier is a triblock copolymer of a hard-soft-hard configuration, which permits it to respond to both low and high temperature conditions with good impact properties.

One aspect of the present invention is a thermoplastic polymer blend, comprising (a) a polyester; (b) a polycarbonate; and (c) a tri-block copolymer of an aromatic monomer, an olefin monomer, and an alkyl (meth)acrylate monomer.

Another aspect of the present invention is a thermoplastic polymer blend, comprising (a) two thermoplastic polycondensate polymers and (b) a combination of impact modifiers, wherein the combination comprises (i) a core/shell additive having an elastomeric core, (ii) a linear terpolymer of ethylene, alkyl (meth)acrylate, and a monomer which contains a heterocycle containing one oxygen atom as the hetero-atom, and (iii) a tri-block copolymer of an aromatic monomer, an olefin monomer, and an alkyl (meth)acrylate monomer. Other aspects of the invention include making and using blends described above.

One feature of the blends of the present invention is good impact properties at service temperatures ranging from about −40° C. to 70° C. without compromising other physical properties otherwise present, e.g., flexural modulus, tensile strength, and heat distortion temperature.

An advantage of the blends of the present invention is that a single compound can be used as parts for a machine that requires service temperatures ranging from about −40° C. to 70° C., even though certain parts have different temperature requirements within that range. For example, in an exterior automotive application, the same part can function predictably notwithstanding its use in Alaska in the winter and Arizona in the summer. Moreover, a part designed to be adjacent a heat source can function even in a very cold environment, for example, a snow blower engine housing.

Another advantage of the blends of the present invention is that the blend can be pigmented according to design choice of the manufacturer with an excellent surface finish.

Another advantage of the blends of the present invention is that the triblock copolymer impact modifier used in the present invention can also serve as a compatibilizer because it has both polar and nonpolar blocks.

Other features and advantages will be revealed in the discussion of the embodiments below.

### EMBODIMENTS OF THE INVENTION

Thermoplastic Polymers to be Impact Modified

The thermoplastic polymers can be one or a number of polymers of the polycondensate type including without limitation, polyamides; polyetheresteramides (PEBAX); polycarbonates (PC); polyesters (such as polyethylene terephthalate (PET), polypropylene terephthalate (PPT), polybutylene terephthalate (PBT), poly(ethylene-2,6-napthalate) (PEN), polypropylene napthalate (PPN), poly(1,4-cyclohexanedimethanol terephthalate) (PCT), polyethylene naphthalate bibenzoate (PENBB), polybutylene naphthalate (PBN)); and liquid crystalline polymers (LCP); and blends of any two or more of them. Of these possibilities, a blend of polycarbonate and a polyester is desirable with a blend of PC with either PET or PBT being preferred. A commercially available blend of PC/PET or PC/PBT is branded as Xenoy from General Electric Company, Plastics Group.

The amount of thermoplastic polymer in the compound can range from about 50 to about 95, and preferably from about 60 to about 80 weight percent of the blend.

The relative contribution of the polycarbonate to the blend ranges from about 15 to about 85 weight percent, and preferably from about 20 to about 50 weight percent.

The relative contribution of the polyester to the blend ranges from about 15 to about 85 weight percent, and preferably from about 35 to about 65 weight percent.

Triblock Copolymer Impact Modifier

Departing from the prior art, the blends of the present invention contain a new impact modifier, tri-block copolymers constructed of three linear chains covalently bonded to one another. The three blocks are an aromatic monomer, an olefin monomer, and an alkyl (meth)acrylate monomer.

As presently known, the only commercially available tri-block copolymers useful as impact modifiers use styrene.

The relative contribution of the aromatic monomer to the tri-block copolymer ranges from about 20 to about 55, and preferably from about 33 to about 46 weight percent of the copolymer.

Non-limiting examples of the olefin monomer are alkyl monomers having four carbon atoms: butylene, and butadiene. Butadiene is preferred because of its low glass transition temperature (−85° C.), its heat stability, and its better affinity with fillers such as carbon black.

The relative contribution of the olefin monomer to the tri-block copolymer ranges from about 7 to about 40, and preferably from about 14 to about 33 weight percent.

Non-limiting examples of the alkyl (meth)acrylate monomer include tert-butylmethacrylate and methylmethacrylate, with mostly syndiotactic methylmethacrylate being preferred due to a high glass transition temperature (135° C.), better miscibility with some polymers such as PC and PVC, and increased heat stability.

The relative contribution of the alkyl (meth)acrylate monomer to the tri-block copolymer ranges from about 20 to about 55, and preferably from about 20 to about 33 weight percent.

Such tri-block copolymers are commercially available such as the styrene-butadiene-methylmethacrylate family of products commercially available as “SBM” from Atofina Chemicals, Inc. of Philadelphia, Pa.

Such tri-block copolymer impact modifier can be included in the blend of the present invention in an amount from about 3 to about 25, and preferably from about 5 to about 15 weight percent of the blend. Most preferably, the amount is about 7 to about 12 weight percent of the blend.

Not being limited to a particular theory, one advantage of using SBM tri-block copolymer as an impact modifier is that the copolymer provides nano-structuralization in the polymer matrix to better absorb energy during impact.

Optional Core/Shell Impact Modifier

This optional impact modifier is comprised of a core/shell additive comprised of core based on alkyl acrylate, on a polyorganosiloxane rubber or a blend thereof and a shell based on poly(alkyl methacrylate), or on a styrene-acrylonitrile copolymer. Preferably the core/shell additive comprises from: (a) 70% to 90% by weight, of an elastomeric crosslinked core which is comprised of: 1) of 20% to 100% by weight, of a nucleus composed of a copolymer (I) of n-alkyl acrylate, the alkyl group of which has a carbon number ranging from 5 to 12, and preferably ranging from 5 to 8, or of a mixture of alkyl acrylates, the linear or branched alkyl group of which has a carbon number ranging from 2 to 12, or of a polyorganosiloxane rubber, of a polyfunctional crosslinking agent possessing unsaturated groups in its molecule, at least one of which is of CH2═C<vinyl type, and optionally of a polyfunctional grafting agent possessing unsaturated groups in its molecule, at least one of which is of CH2═CH—CH2-alkyl type, the said nucleus containing a molar amount of crosslinlcing agent and optionally of grafting agent ranging from 0.05% to 5% and preferably an amount of between 0.5% and 1.5%; 2) of 80% to 0% by weight of a covering composed of a copolymer (II) of n-alkyl acrylate, the alkyl group of which has a carbon number ranging from 4 to 12, or of a mixture of alkyl acrylates as defined above in 1) and of a polyfunctional grafting agent possessing unsaturated groups in its molecule, at least one of which is of CH2═CH—CH2-alkyl type, the said covering containing a molar amount of grafting agent ranging from 0.05% to 2.5%; (b) 30% to 10% by weight, of a shell grafted onto the said core composed of a polymer of an alkyl methacrylate, the alkyl group of which has a carbon number ranging from 1 to 4, or alternatively of a statistical copolymer of an <DP=2 alkyl methacrylate, the alkyl group of which has a carbon number ranging from 1 to 4, and of an alkyl acrylate, the alkyl group of which has a carbon number ranging from 1 to 8, containing a molar amount of alkyl acrylate ranging from 5% to 40%, or alternatively composed of a styrene-acrylonitrile copolymer having a preferred styrene:acrylonitrile molar ratio between 1:1 and 4: 1, and particularly between 7:3 and 3:1, respectively; wherein optionally 0.1 to 50 weight percent of vinyl monomers have functional groups.

Such core/shell impact modifiers are commercially available such as the n-octyl acrylate rubber core/polymethylmethacrylate shell product commercially available as “D-400” from Atofina Chemicals, Inc. of Philadelphia, Pa.

Such core/shell impact modifier can be included in the blend of the present invention in an amount from about 0 to about 10, and preferably from 20 about 0 to about 7. Most preferably, the amount is about 1 to about 5 percent by weight of the blend.

Optional Linear Terpolymer Impact Modifier

This optional impact modifier comprises a linear terpolymer of (a) ethylene, (b) a lower alkyl acrylate and (c) a monomer which contains a heterocycle containing one oxygen atom as the hetero-atom.

“Lower alkyl acrylate” means a C₁-C₈ and preferably a C₁-C₄ alkyl ester of (meth)acrylic acid. Of these possibilities, methyl acrylate is preferred.

Preferably the heterocyclic monomer contains an epoxy atom.

Relative amounts of monomer in the terpolymer range from 55-75 weight percent ethylene, 20-30 weight percent lower alkyl acrylate, and 5-15 weight percent heterocyclic monomer.

Such linear terpolymer impact modifiers are commercially available such as the ethylene-methyl acrylate-glycidyl methacrylate product commercially available as “Lotader AX 8900” from Atofina Chemicals, Inc. of Philadelphia, Pa.

Such linear terpolymer impact modifier can be included in the blend of the present invention in an amount from about 0 to about 10, and preferably from about 0 to about 7. Most preferably, the amount is about 1 to about 5 percent by weight of the blend.

Each of the three impact modifiers can be in powder, flake, or pellet form. They can be blended together into a concentrate or mixed with the thermoplastic polymers during melt processing in preparation for direct molding or pelletization for later molding.

Optional Additives

As with many thermoplastic compounds, it is optional and desirable to include other additives to improve processing or performance. Non-limiting examples of such optional additives include slip agents, antiblocking agents, antioxidants, ultraviolet light stabilizers, quenchers, dyes and pigments, plasticizers, mold release agents, lubricants, antistatic agents, fire retardants, and fillers such as glass fibers, talc, chalk, or clay. Of these fillers, the properties of nanoclay can add stiffness, toughness, and charring properties for flame retardancy.

Such optional additives can be included in the blend of the present invention in an amount from about 0 to about 40, and preferably from about 0.1 to about 30 weight percent. Most preferably, the amount is about 1 to about 7 weight percent of the blend.

Method of Processing Blends

The blend of the present invention can be prepared by any method which makes it possible to produce a thoroughly mixed blend containing at least one of the thermoplastic polycondensate polymers, the combination of impact modifiers described above, and other optional additives, if any. It is possible, for example, to dry-mix the ingredients constituting the compound, then to extrude the resulting mixture and to reduce the extrudate to pellets. When the thermoplastic polycondensate polymer(s) is/are obtained by emulsion polymerization, it can be convenient to mix the emulsion containing the impact modifier combination according to the invention with the emulsion of the thermoplastic polycondensate polymer and to treat the resulting emulsion in order to separate therefrom the solid product.

As an example, extrusion can be carried out in a suitable extruder, such as a Werner-Pfleiderer co-rotating twin screw extruder. The extruder should be capable of screw speeds ranging from about 50 to about 12000 rpm. The temperature profile from the barrel number two to the die should range from about 170° C. to about 270° C., and preferably from about 220° C. to about 270° C., depending on the ingredients of the melt. The extruder can be fed separately with the ingredients of the blend or together.

The selected temperature range should be from about 200° C. to about 260° C. for a PC/PBT based blend or a PC/PET based blend. The extrudate can be pelletized or directed into a profile die. If pelletized, the pellets can then be molded by injection, compression, or blow molding techniques known to those skilled in the art.

Preferably, one can introduce the polycarbonate and the polyester in split feed streams in two different ports of the extruder (main throat and down stream locations) with the use of both atmospheric vents and vacuum vents as preferred by those skilled in the art. High specific energy input is desirable to reduce the size of the impact modifier particles and to encourage uniform dispersion in the thermoplastic polymers. One can use a temperature profile of between 200 and 260° C., depending on the number and type of optional additives also included in the extruded blend.

Usefulness of the Invention

Impact-modified thermoplastic polymer blends of the present invention are useful for transportation-related molded items (e.g., crash helmets and parts for vehicles such as bumpers and fenders); electrical equipment when flame retardants or reinforcing fillers are also added (e.g., plugs, connectors, boxes, and switches); and consumer appliance housings and containers (e.g., kitchen appliance housings and shells, and consumer electronics housings and cases).

Further embodiments of the invention are described in the following Examples.

### EXAMPLES

Test Methods

Table 1 shows the test methods used in conjunction with the evaluation of the examples.

TABLE 1

| Test Name | Test Method |
|---|---|
| Heat Distortion | ASTM D648 |
| Tensile Strength | ASTM D638 |
| Flexural Modulus | ASTM D790 |
| Notched Izod Impact Strength | ASTM D256 |
| % Elongation at Break | ASTM D638 Rigid |

Blend Ingredients and Order of Addition

Table 2 shows the ingredients of Example 1 and Comparative Example A. Table 3 shows the order of delivery to a Werner-Pfleiderer ZSK-25 co-rotating twin-screw extruder operating at 250° C. (T-melt) and 900 rpm speed. The extrudate was pelletized and subsequently injection molded into the various required test forms on a Nissei injection molding machine operating at 250° C. (T-melt).

TABLE 2

| Trade Name | Source | Generic Description |
|---|---|---|
| PBT-610 | DuPont | Polybutylene terephthalate |
| D-400 | Atofina Chemicals | Core/Shell Impact Modifier |
| | | (nOA/MMA) |
| Lotader AX 8900 | Atofina Chemicals | Linear Terpolymer Impact |
| | | Modifier (E-MA-GMA) |
| Ultranox 626 | Crompton | Diphosphite stabilizer |
| Irganox 1010 | Ciba-Geigy | Phenolic antioxidant |
| Mark 135A | Crompton | Diphosphite stabilizer |
| 412s | Crompton | Thioester stabilizer |
| AC 540 | Honeywell | Polyethylene wax |
| PC | Commercial Plastic | Polycarbonate |
| | Recycling | |
| SBM | Atofina Chemicals | Triblock Copolymer Impact |
| | | Modifier (styrene-butadiene- |
| | | methylmethacrylate) |

TABLE 3

| | | |
|---|---|---|
| | Comparative | |
| Raw Materials | Example A | Example 1 |

Feed at Throat:

| | | |
|---|---|---|
| PBT-610 | 27.98% | 28.67% |
| D-400 | 2.41% | 0.49% |
| Lotader AX 8900 | 4.82% | 0.99% |
| Ultranox 626 | 0.96% | 0.98% |
| Irganox 1010 | 0.32% | 0.33% |
| Mark 135A | 0.21% | 0.22% |
| 412s | 0.21% | 0.22% |
| AC 540 | 1.59% | 1.63% |
| SBM | — | 4.94% |

Feed at Downstream Port:

| | | |
|---|---|---|
| Repro-PC | 59.09% | 60.55% |
| D-400 | 2.41% | 0.99% |
| Impact Modifier Content | 9.64% | 7.41% |

Results

Table 4 shows the experimental results.

TABLE 4

| | | Comparative | |
|---|---|---|---|
| Test | | Example A | Example 1 |
| Heat Distortion | Trial 1 | 92 | 95 |
| (° C.) with 66 psi | Trial 2 | 95 | 98 |
| Distortion | Average | 93.5 | 96.5 |
| Heat Distortion | Trial 1 | 79 | 81 |
| (° C.) | Trial 2 | 79 | 82 |
| with 264 psi Distortion | Average | 79 | 81.5 |

| | | |
|---|---|---|
| Stress at Yield (psi) | 7446 | 8530 |
| Stress at Break (psi) | 6340 | 6644 |
| Flexural Modulus (psi × 1000) | 325.4 | 363 |
| Average Impact (ft * lb/in) @ 23° C. | 15.35 | 15.20 |
| Average Impact (ft * lb/in) @ −20° C. | 3.58 | 2.88 |
| Average Impact (ft * lb/in) @ −40° C. | 2.92 | 2.34 |
| Elongation Strain at Break (%) | 110 | 100 |

Table 4 shows that Example 1 outperforms Comparative Example A even though it had 22% less total impact modifier (7.4% vs. 9.6%). Example 1 had a combination of three impact modifiers, whereas Comparative Example A did not include the Triblock Copolymer Impact Modifier. Example 1 had better heat distortion resistance, better tensile strength, and better flexural modulus and comparable impact strength than Comparative Example A.

The invention is not limited to the above embodiments. The claims follow.

What is claimed is:

1. A thermoplastic polymer blend, comprising:
(a) two thermoplastic polycondensate polymers and
(b) a combination of impact modifiers,
wherein the combination comprises:
(i) a core/shell additive having an elastomeric core,
(ii) a linear terpolymer of ethylene, alkyl (meth)acrylate, and a monomer which contains a heterocycle containing one oxygen atom as the hetero-atom, and
(iii) a tri-block copolymer of an aromatic monomer, an olefin monomer, and an alkyl (meth)acrylate monomer.

2. The blend of claim 1, wherein the polycondensate polymers are selected from the group consisting of polyamides; polyetheresteramides (PEBAX); polycarbonates (PC); polyesters; liquid crystalline polymers (LCP); and blends of any three or more of them.

3. The blend of claim 2, wherein the polyesters comprise polyethylene terephthalate (PET), polypropylene terephthalate (PPT), polybutylene terephthalate (PBT), poly(ethylene-2,6-napthalate) (PEN), polypropylene napthalate (PPN), poly(1,4-cyclohexanedimethanol terephthalate) (PCT), polyethylene naphthalate bibenzoate (PENBB), or polybutylene naphthalate (PBN).

4. The blend of claim 1, wherein the at least one polycondensate polymer is plural and comprises polycarbonate and polyester.

5. The blend of claim 4, wherein the tri-block copolymer is styrene-butadiene-methylmethacrylate.

6. The blend of claim 5, wherein the core/shell additive is n-octyl acrylate rubber core/polymethylmethacrylate shell and wherein the linear terpolymer is ethylene-methyl acrylate-glycidyl methacrylate.

7. The blend of claim 6,
wherein the amount of triblock copolymer ranges from about 3 to about 25 weight percent of the blend;
wherein the amount of core/shell additive ranges from 0 to about 10 weight percent of the blend; and
wherein the amount of linear terpolymer ranges from 0 to about 10 weight percent of the blend.

8. The blend of claim 1, further comprising optional additives selected from the group consisting of slip agents, antiblocking agents, antioxidants, ultraviolet light stabilizers, quenchers, dyes and pigments, plasticizers, mold release agents, lubricants, antistatic agents, fire retardants, fillers, and combinations thereof.

9. The blend of claim 8, wherein the fillers comprise glass fibers, talc, chalk, or clay.

10. The blend of claim 9, wherein the clay is a nanoclay.

11. An article made from the blend of claim 1.

12. A thermoplastic polymer blend, comprising:
(a) a polyester,
(b) a polycarbonate, and
(c) a tri-block copolymer of an aromatic monomer, an olefin monomer, and an alkyl (meth)acrylate monomer.

13. The blend of claim 12, further comprising (d) a core/shell additive having an elastomeric core and (e) a linear terpolymer of ethylene, alkyl (meth)acrylate, and a monomer which contains a heterocycle containing one oxygen atom as the hetero-atom.

14. The blend of claim 12, wherein the polyester is selected from the group consisting of polyethylene terephthalate (PET), polypropylene terephthalate (PPT), polybutylene terephthalate (PBT), poly(ethylene-2,6-napthalate) (PEN), polypropylene napthalate (PPN), poly(1,4-cyclohexanedimethanol terephthalate) (PCT), polyethylene naphthalate bibenzoate (PENBB), or polybutylene naphthalate (PBN).

15. The blend of claim 14, wherein the tri-block copolymer is styrene-butadiene-methylmethacrylate.

16. The blend of claim 13, wherein the core/shell additive is n-octyl acrylate rubber core/polymethylmethacrylate shell and wherein the linear terpolymer is ethylene-methyl acrylate-glycidyl methacrylate.

17. The blend of claim 13,
wherein the amount of triblock copolymer ranges from about 3 to about 25 weight percent of the blend;
wherein the amount of core/shell additive ranges from 0 to about 10 weight percent of the blend; and
wherein the amount of linear terpolymer ranges from 0 to about 10 weight percent of the blend.

18. The blend of claim 12, further comprising optional additives selected from the group consisting of slip agents, antiblocking agents, antioxidants, ultraviolet light stabilizers, quenchers, dyes and pigments, plasticizers, mold release agents, lubricants, antistatic agents, fire retardants, fillers, and combinations thereof.

19. The blend of claim 8, wherein the fillers comprise glass fibers, talc, chalk, or clay.

20. An article made from the blend of claim 12.
